(19) United States
(12) Patent Application Publication
(10) Pub. No.: US 2022/0228326 A1
(43) Pub. Date: Jul. 21, 2022

(54) MULTI-FUNCTIONAL ARTIFICIAL LAWN WITH OVERLOCK

(71) Applicant: COCREATION GRASS CO., LTD, Huaian (CN)

(72) Inventors: Yijia Wu, Huaian (CN); Chungui Zhao, Huaian (CN)

(73) Assignee: COCREATION GRASS CO., LTD, Huaian (CN)

(21) Appl. No.: 17/229,749

(22) Filed: Apr. 13, 2021

(30) Foreign Application Priority Data
Jan. 21, 2021 (CN) 2021201680192

(51) Int. Cl. E01C 13/08; B32B 5/02; B32B 3/08; B32B 7/12; B32B 27/32; B32B 27/12; B32B 5/26

(52) U.S. Cl. CPC E01C 13/08; B32B 5/022; B32B 3/08; B32B 5/265; B32B 27/32; B32B 27/12; B32B 7/12

(57) ABSTRACT

The present disclosure relates to the technical field of artificial lawn. A multi-functional artificial lawn with overlock is disclosed, including an artificial grass, a base cloth layer, an anti-skid layer and an overlock structure. The artificial grass is tufted on the base cloth layer. The anti-skid layer is bonded to a bottom of the base cloth layer. Peripheral edges of the base cloth layer and the anti-skid layer are provided with the overlock structure. And the overlock structure is formed by overlocking polyester thread. The provided multi-functional artificial lawn with overlock effectively solves a series of problems such as difficult storage, low reuse rate, and black silk falling off at the edges of the lawn.

### TECHNICAL FIELD

The present disclosure relates to the technical field of artificial lawn, and more specifically, to a multi-functional artificial lawn with overlock.

### BACKGROUND

In recent years, the artificial lawn industry has developed rapidly. Artificial lawn has obvious advantages in cost, maintenance, durability and evergreen. In China, artificial lawn is expected to become the main material for community leisure. In community child playground, artificial lawn will gradually replace the plastic floor. In the world, leisure grass has gradually penetrated into daily life and become a fast-selling product. In order to accelerate the application of artificial lawn in leisure and seek the rapid development of the market, it is necessary to develop new technology, new process field and carry out forward-looking research and layout.

At present, the conventional artificial lawn back is carboxylated styrene-butadiene rubber latex and polyurethane adhesive, which is hard and poor in water resistance. When the lawn with the existing back is cut into small lawn mats, there are a series of problems, such as difficult storage, low reuse rate, and black silk falling off at the edges of the lawn.

Therefore, it is an urgent problem for those skilled in the art to provide an artificial lawn to prevent falling off with high reuse rate.

### SUMMARY

In view of the above, the present disclosure is to provide a multi-functional artificial lawn with overlock to solve a series of problems, such as difficult storage, low reuse rate, and black silk falling off at the edges of the lawn.

In order to achieve the above purpose, technical solutions of the present disclosure are specifically described as follows.

A multi-functional artificial lawn with overlock includes an artificial grass, a base cloth layer, an anti-skid layer and an overlock structure. The artificial grass is tufted on the base cloth layer. The anti-skid layer is bonded to a bottom of the base cloth layer. Peripheral edges of the base cloth layer and the anti-skid layer are provided with the overlock structure. And the overlock structure is formed by overlocking polyester thread.

Preferably, in the above multi-functional artificial lawn with overlock, the overlock structure is one of two-thread overlock structure, three-thread overlock structure, four-thread overlock structure and five-thread overlock structure. Preferably the two-thread overlock structure and the three-thread overlock structure, more preferably the three-thread overlock structure, can make the artificial lawn structure more concise and beautiful.

Preferably, in the above multi-functional artificial lawn with overlock, the two-thread overlock structure includes a face thread and a locking thread.

Preferably, in the above multi-functional artificial lawn with overlock, the three-thread overlock structure, the four-thread overlock structure and the five-thread overlock structure all includes a face thread, a bottom thread and a locking thread.

Preferably, in the above multi-functional artificial lawn with overlock, the face thread, the bottom thread and the locking thread are three kinds of polyester threads with the same specification, or at least one kind of polyester threads is with different specifications.

Preferably, in the above multi-functional artificial lawn with overlock, for the face thread and the locking thread, 3000Y-5000Y polyester thread is selected, and for the bottom thread, 500Y-2000Y polyester thread is selected. Thus, the overall look is heavier and classier. And the bottom thread with small gram weight is adopted, so that the lawn and the contact surface are attached more evenly.

Preferably, in the above multi-functional artificial lawn with overlock, a overlock width of the overlock structure is 0.5-1.5 cm.

Preferably, in the above multi-functional artificial lawn with overlock, a overlock width of the overlock structure is 0.6-1.0 cm.

Preferably, in the above multi-functional artificial lawn with overlock, when an area of the artificial lawn is less than 1 m², the width of the overlock structure is 0.6-0.7 cm; and when an area of the artificial lawn is more than 1 m², the width of the overlock structure is 0.7-1 cm.

Preferably, in the above multi-functional artificial lawn with overlock, the anti-skid layer is a mixture of one or more of TPE adhesive layer, TPR adhesive layer, EVA adhesive layer, PE plastic layer, POE adhesive layer and point-plastic non-woven fabric layer.

According to the above technical scheme, compared with the prior art, the present disclosure provides a multi-functional artificial lawn with overlock. The artificial lawn can be used as door mat, picnic mat, damp proof mat, yoga mat, kindergarten lawn carpet, etc. In addition, the disclosure effectively solves a series of problems such as difficult storage, low reuse rate, and black silk falling off at the edges of the lawn. A overlock structure is provided around the edges of the lawn, so that the lawn is more beautiful and the product is classier.

### BRIEF DESCRIPTION OF THE DRAWINGS

In order to explain the embodiments of the present disclosure or the technical solutions in the prior art more clearly, the following drawings that need to be used in the description of the embodiments or the prior art will be briefly introduced. Obviously, the drawings in the following description are only embodiments of the present disclosure. For those of ordinary skill in the art, other drawings can be obtained based on the drawings disclosed without creative work.

FIG. 1 is a side view of the multi-functional artificial lawn with overlock;

FIG. 2 is a top view of the multi-functional artificial lawn with overlock; wherein, 1 is the artificial grass, 2 is the base cloth layer, 3 is the anti-skid layer, and 4 is the overlock structure.

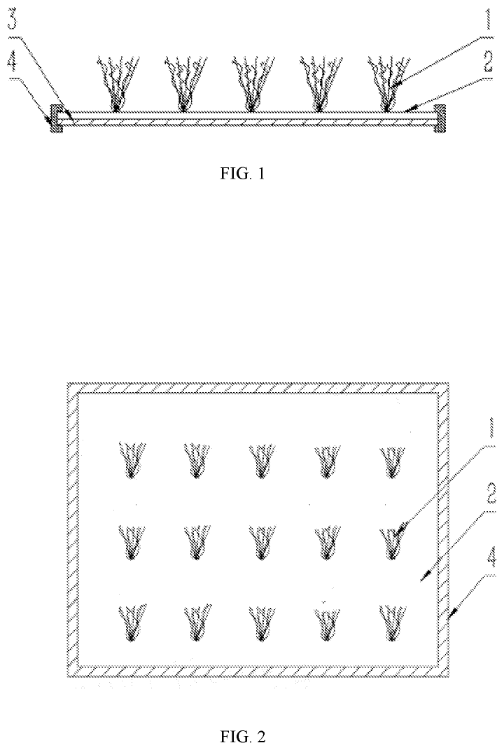

### DETAILED DESCRIPTION OF EMBODIMENTS

Technical solutions of the present disclosure will be clearly and completely described below with reference to the embodiments. Obviously, the described embodiments are only part of the embodiments of the present disclosure, not all of them. Other embodiments made by those skilled in the art without sparing any creative effort should fall within the scope of the disclosure.

### Embodiment 1

A multi-functional artificial lawn with overlock is provided. Firstly, the double twisting artificial grass 1 is tufted on the base cloth layer 2 to make a semi-finished lawn; then, a layer of TPE anti-skid layer 3 is coated on the back of the semi-finished lawn with tufting; the anti-skid layer weight is 1 kg/m² after the embossing roller hot pressing anti-skid pattern; finally, overlocking is carried out around the lawn. The overlock structure 4 is the two-thread overlock structure, and the specifications of two kinds of polyester threads are 3000Y.

The artificial grass 1 includes at least one of straight fiber, curved fiber and open web fiber, and the artificial grass 1 is with different cross-section shapes and/or different thicknesses and/or different colors. The overlock thread can also be polyester pile yarn.

### Embodiment 2

A multi-functional artificial lawn with overlock is provided. Firstly, the double twisting artificial grass 1 is tufted on the base cloth layer 2 to make a semi-finished lawn; then, a layer of TPE anti-skid layer 3 is coated on the back of the semi-finished lawn with tufting; the anti-skid layer weight is 0.8 kg/m² after the embossing roller hot pressing anti-skid pattern; finally, overlocking is carried out around the lawn. The overlock structure 4 is the three-thread overlock structure, and the face thread and the locking thread are 3000Y polyester threads, and the bottom thread is 1000Y polyester thread.

The artificial grass 1 includes at least one of straight fiber, curved fiber and open web fiber, and the artificial grass 1 is with different cross-section shapes and/or different thicknesses and/or different colors. The overlock thread can also be polyester pile yarn.

### Embodiment 3

A multi-functional artificial lawn with overlock is provided. Firstly, the double twisting artificial grass 1 is tufted on the base cloth layer 2 to make a semi-finished lawn; then, a layer of PE anti-skid layer 3 is coated on the back of the semi-finished lawn with tufting; the anti-skid layer weight is 0.5 kg/m² after the embossing roller hot pressing anti-skid pattern; finally, overlocking is carried out around the lawn. The overlock structure 4 is the three-thread overlock structure, and the specifications of three kinds of polyester threads are 3000Y.

The artificial grass 1 includes at least one of straight fiber, curved fiber and open web fiber, and the artificial grass 1 is with different cross-section shapes and/or different thicknesses and/or different colors. The overlock thread can also be polyester pile yarn.

### Embodiment 4

A multi-functional artificial lawn with overlock is provided. Firstly, the double twisting artificial grass 1 is tufted on the base cloth layer 2 to make a semi-finished lawn; then, a layer of the PE plastic layer is coated on the back of the semi-finished lawn with tufting for fixing; the weight of the PE plastic layer is 0.4 kg/m², and a layer of the point-plastic non-woven fabric layer is attached to the back of the PE plastic layer to form an anti-skid layer 3; finally, overlocking is carried out around the lawn. The overlock structure 4 is the four-thread overlock structure, and the face thread and the locking thread are 2000Y polyester threads, and the bottom thread is 600Y polyester thread.

The artificial grass 1 includes at least one of straight fiber, curved fiber and open web fiber, and the artificial grass 1 is with different cross-section shapes and/or different thicknesses and/or different colors. The overlock thread can also be polyester pile yarn.

### Embodiment 5

A multi-functional artificial lawn with overlock is provided. Firstly, the double twisting artificial grass 1 is tufted on the base cloth layer 2 to make a semi-finished lawn; then, a layer of TPE anti-skid layer 3 is coated on the back of the semi-finished lawn with tufting; the anti-skid layer weight is 0.7 kg/m² after the embossing roller hot pressing anti-skid pattern; finally, overlocking is carried out around the lawn. The overlock structure 4 is the three-thread overlock structure, and the face thread and the locking thread are 5000Y polyester threads, and the bottom thread is 2000Y polyester thread.

The artificial grass 1 includes at least one of straight fiber, curved fiber and open web fiber, and the artificial grass 1 is with different cross-section shapes and/or different thicknesses and/or different colors. The overlock thread can also be polyester pile yarn.

### Embodiment 6

A multi-functional artificial lawn with overlock is provided. Firstly, the double twisting artificial grass 1 is tufted on the base cloth layer 2 to make a semi-finished lawn; then, a layer of EVA anti-skid layer 3 is coated on the back of the semi-finished lawn with tufting; the anti-skid layer weight is 0.7 kg/m² after the embossing roller hot pressing anti-skid pattern; finally, overlocking is carried out around the lawn. The overlock structure 4 is the three-thread overlock structure, and the face thread and the locking thread are 5000Y polyester threads, and the bottom thread is 2000Y polyester thread.

The artificial grass 1 includes at least one of straight fiber, curved fiber and open web fiber, and the artificial grass 1 is with different cross-section shapes and/or different thicknesses and/or different colors. The overlock thread can also be polyester pile yarn.

Each embodiment in this specification is described in a progressive manner, and each embodiment focuses on the differences from other embodiments. The same and similar parts of each embodiment can be referred to each other. For the device disclosed by the embodiment, the description is relatively simple because it corresponds to the method disclosed by the embodiment. For the relevant points, please refer to the description of the method section.

The above description of the disclosed embodiments enables those skilled in the art to realize or use the present disclosure. Many modifications to these embodiments will be apparent to those skilled in the art. The general principle defined herein can be realized in other embodiments without departing from the spirit or scope of the present invention. Therefore, the present disclosure will not be limited to these embodiments shown herein, but will conform to the widest scope consistent with the principle and novel features disclosed herein.

We claim:

1. A multi-functional artificial lawn with overlock, comprising an artificial grass (1), a base cloth layer (2), an anti-skid layer (3) and an overlock structure (4); wherein the artificial grass (1) is tufted on the base cloth layer (2); the anti-skid layer (3) is bonded to a bottom of the base cloth layer (2); peripheral edges of the base cloth layer (2) and the anti-skid layer (3) are provided with the overlock structure (4); and the overlock structure (4) is formed by overlocking polyester thread.

2. The multi-functional artificial lawn with overlock of claim 1, wherein the overlock structure (4) is one of two-thread overlock structure, three-thread overlock structure, four-thread overlock structure and five-thread overlock structure.

3. The multi-functional artificial lawn with overlock of claim 2, wherein the two-thread overlock structure comprises a face thread and a locking thread.

4. The multi-functional artificial lawn with overlock of claim 2, wherein the three-thread overlock structure, the four-thread overlock structure and the five-thread overlock structure all comprise a face thread, a bottom thread and a locking thread.

5. The multi-functional artificial lawn with overlock of claim 4, wherein the face thread, the bottom thread and the locking thread are three kinds of polyester threads with the same specification, or at least one kind of polyester threads is with different specifications.

6. The multi-functional artificial lawn with overlock of claim 1, wherein a overlock width of the overlock structure (4) is 0.5-1.5 cm.

7. The multi-functional artificial lawn with overlock of claim 6, wherein a overlock width of the overlock structure (4) is 0.6-1.0 cm.

8. The multi-functional artificial lawn with overlock of claim 7, wherein when an area of the artificial lawn is less than 1 m², the width of the overlock structure (4) is 0.6-0.7 cm; and when an area of the artificial lawn is more than 1 m², the width of the overlock structure (4) is 0.7-1 cm.

9. The multi-functional artificial lawn with overlock of claim 1, wherein the anti-skid layer (3) is a mixture of one or more of TPE adhesive layer, TPR adhesive layer, EVA adhesive layer, PE plastic layer, POE adhesive layer and point-plastic non-woven fabric layer.
